(19) United States
(12) Patent Application Publication
(10) Pub. No.: US 2026/0302195 A1
(43) Pub. Date: Oct. 1, 2026

(54) NEGATIVE ELECTRODE AND LITHIUM ION SECONDARY BATTERY

(71) Applicant: HONDA MOTOR CO., LTD., Tokyo (JP)

(72) Inventors: Takafumi NAGAI, Saitama (JP); Wataru HOSHIKAWA, Saitama (JP); Wataru SHIMIZU, Saitama (JP); Narumi OHTA, Saitama (JP); Hiroshi SAKAI, Saitama (JP); Masataka FURUYAMA, Saitama (JP); Shodai KATO, Saitama (JP)

(21) Appl. No.: 19/629,421

(22) Filed: Mar. 26, 2026

(30) Foreign Application Priority Data
Mar. 31, 2025 (JP) 2025-057612

(51) Int. Cl. H01M 4/38; H01M 4/02; H01M 4/36; H01M 10/0525; H01M 10/0562

(52) U.S. Cl. CPC H01M 4/386; H01M 4/364; H01M 10/0525; H01M 10/0562; H01M 2004/027

(57) ABSTRACT

A negative electrode containing:
a silicon-based active material and a solid electrolyte, wherein
at least a part of a surface of the active material is coated with a coating layer, and
the coating layer contains a metal element capable of forming an alloy with lithium.

### BACKGROUND

### Technical Field

The present invention relates to a negative electrode and a lithium ion secondary battery.

### Related Art

In order to obtain expected capacity, resistance, and durability in an all-solid-state battery, it is necessary to maintain electron conduction and ion conduction paths at an interface between an active material and a solid electrolyte while repeating charge and discharge. Here, when a silicon-based active material is used as the negative electrode active material, interfacial peeling between the negative electrode active material and the solid electrolyte is confirmed due to a large volume variation of the active material during charging. This interfacial peeling causes disconnection of electron conduction and ion conduction paths, and thus performance degradation occurs.

As a method for eliminating interfacial peeling, an approach has been made to improve the bonding area of the interface between the active material and the solid electrolyte by using a coated active material in which the surface of the active material is coated with the solid electrolyte (see, for example, WO 2023/198886 A, US 2020/0373580 A, JP 7251069 B1, and U.S. Pat. No. 11,223,036).

### CITATION LIST

### Patent Literature

Patent Literature 1: WO 2023/198886 A
Patent Literature 2: US 2020/0373580 A
Patent Literature 3: JP 7251069 B1
Patent Literature 4: U.S. Pat. No. 11,223,036

### SUMMARY

In the method of coating the surface of the active material with the solid electrolyte, the effect of reducing the resistance at the interface between the active material and the solid electrolyte has been reported.

However, with respect to expansion and contraction of the active material, peeling between the coated active material and the solid electrolyte in the electrode in contact with the coated active material has been observed, and there has been a problem in reaction resistance during a cycle test.

The present invention has been made to solve the above problems, and an object thereof is to provide a negative electrode capable of reducing reaction resistance during a cycle test, and a lithium ion secondary battery including the negative electrode. In addition, the present invention also contributes to improvement of energy efficiency, accordingly.

In order to achieve the above object, the present invention provides the following configurations.
[1] A negative electrode containing:
a silicon-based active material and a solid electrolyte, wherein
at least a part of a surface of the active material is coated with a coating layer, and
the coating layer contains a metal element capable of forming an alloy with lithium.

In the negative electrode according to [1], at least a part of the surface of the active material is coated with a coating layer containing a specific metal element. Therefore, the peeling between the active material and the solid electrolyte associated with expansion and contraction of the active material can be suppressed, and the reaction resistance during the cycle test can be reduced. Accordingly, it is possible to reduce energy loss and contribute to improvement of energy efficiency.
[2] The negative electrode according to [1], wherein the metal element is at least one of Ni, In, Sb, and Bi.

In the negative electrode according to [2], the specific metal element contained in the coating layer is at least one of Ni, In, Sb, and Bi. Therefore, the peeling between the active material and the solid electrolyte can be further suppressed, and the reaction resistance during the cycle test can be further reduced. Accordingly, it is possible to further reduce energy loss and contribute to further improvement of energy efficiency.
[3] The negative electrode according to [1] or [2], wherein the coating layer has a thickness of 10 nm or more and 100 nm or less.

In the negative electrode according to [3], the thickness of the coating layer satisfies a specific numerical range. Therefore, the peeling between the active material and the solid electrolyte can be further suppressed, and the reaction resistance during the cycle test can be further reduced. Accordingly, it is possible to further reduce energy loss and contribute to further improvement of energy efficiency.
[4] The negative electrode according to [1] or [3], wherein the metal element is Sb.

In the negative electrode according to [4], the specific metal element contained in the coating layer is Sb. Therefore, the peeling between the active material and the solid electrolyte can be still further suppressed, and the reaction resistance during the cycle test can be still further reduced. Accordingly, the energy loss can be still further reduced, which can contribute to further improvement of energy efficiency.
[5] The negative electrode according to any one of [1] to [4], wherein the solid electrolyte is a sulfide solid electrolyte.

In the negative electrode according to [5], the solid electrolyte is a sulfide solid electrolyte. Therefore, the peeling between the active material and the solid electrolyte can be still further suppressed, and the reaction resistance during the cycle test can be still further reduced. Accordingly, the energy loss can be still further reduced, which can contribute to further improvement of energy efficiency.
[6] The negative electrode according to any one of [1] to [5], wherein the active material is a composite material of silicon and a different element different from the silicon.

In the negative electrode according to [6], the active material is a composite material of silicon and a different element different from silicon. Therefore, the peeling between the active material and the solid electrolyte can be still further suppressed, and the reaction resistance during the cycle test can be still further reduced. Accordingly, the energy loss can be still further reduced, which can contribute to further improvement of energy efficiency.
[7] A lithium ion secondary battery including the negative electrode according to any one of [1] to [6], a positive electrode, and a solid electrolyte layer.

The lithium ion secondary battery according to [7] includes the negative electrode according to any one of [1] to [6]. Therefore, the peeling between the active material and the solid electrolyte associated with expansion and contraction of the active material can be suppressed, and the reaction resistance during the cycle test can be reduced. Accordingly, it is possible to reduce energy loss and contribute to improvement of energy efficiency.

According to the negative electrode of the present invention, the reaction resistance during the cycle test can be reduced.

### BRIEF DESCRIPTION OF DRAWINGS

FIG. 1 is a cross-sectional view schematically illustrating a configuration of a lithium ion secondary battery according to an embodiment of the present invention; and

FIG. 2 is a schematic view illustrating an overall image of a silicon-based active material and a coating layer according to an embodiment of the present invention.

### DETAILED DESCRIPTION

Hereinafter, a preferred embodiment of the present invention will be described in detail.

### [Lithium Ion Secondary Battery]

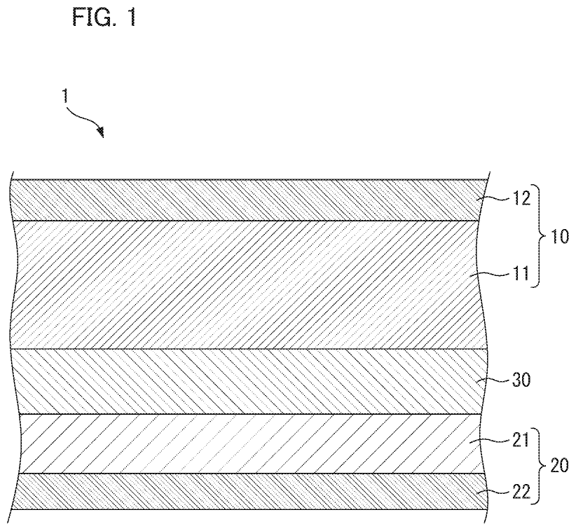

FIG. 1 is a cross-sectional view of a lithium ion secondary battery 1 according to an embodiment of the present invention (hereinafter, also referred to as a “battery”). As illustrated in FIG. 1, a battery 1 includes a positive electrode 10, a negative electrode 20, and a solid electrolyte layer 30. The battery 1 is a laminate in which the positive electrode 10, the solid electrolyte layer 30, and the negative electrode 20 are laminated in this order. The term “battery” as used herein refers to an all-solid-state battery or a semi-solid-state battery.

### <Positive Electrode>

The positive electrode 10 includes a positive electrode layer 11 and a positive electrode current collector 12. The positive electrode layer 11 is disposed on the solid electrolyte layer 30 side. The positive electrode current collector 12 constitutes a surface of the battery 1 on the positive electrode 10 side.

Although not particularly shown, the battery 1 preferably has a known exterior body.

The positive electrode layer 11 contains a positive electrode active material. The positive electrode active material used for the positive electrode layer 11 is not particularly limited as long as it functions as a positive electrode of the battery 1. Specific examples of the positive electrode active material include a layered active material containing lithium, a spinel-type active material, and an olivine-type active material in the case of a lithium ion battery. Specific examples of the positive electrode active material include lithium cobaltate (LiCoO₂), lithium nickelate (LiNiO₂), LiNiₚMn_{q}CoᵣO₂ (p+q+r=1), LiNiₚAl_{q}CoᵣO₂ (p+q+r=1), lithium manganate (LiMn₂O₄), Li—Mn spinel substituted with a different element represented by Li₍₁₊ₓ₎Mn_{(2-x-y)}M_{y}O₄ (x+y=2, M=at least one selected from Al, Mg, Co, Fe, Ni, and Zn), lithium titanate (oxide containing Li and Ti), and lithium metal phosphate (LiMPO₄, M=at least one selected from Fe, Mn, Co, and Ni). In addition, it is also possible to use a mixture of these.

The positive electrode layer 11 may contain a solid electrolyte, a conductive material, and a binder in addition to the positive electrode active material. The solid electrolyte, the conductive material, and the binder will be described later.

The content of the positive electrode active material in the positive electrode layer 11 is, for example, preferably 208 by mass or more, and may be 308 by mass or more, 40% by mass or more, or 50% by mass or more. On the other hand, the content of the positive electrode active material is, for example, preferably 99% by mass or less, and may be 90% by mass or less, 80% by mass or less, 70% by mass or less, or 60% by mass or less.

The thickness of the positive electrode layer 11 is not particularly limited, and can be appropriately set according to the required performance of the battery. The thickness of the positive electrode layer 11 may be, for example, in a range of 0.1 μm or more and 1000 μm or less.

The positive electrode current collector 12 has a function of collecting current from the positive electrode layer 11. The positive electrode current collector 12 is a foil-shaped member made of an electrode material having conductivity. The electrode material used for the positive electrode current collector 12 is not particularly limited as long as it is a material having conductivity, and examples thereof include aluminum, an aluminum alloy, stainless steel, nickel, iron, and titanium. The electrode material used for the positive electrode current collector 12 is preferably at least one selected from the group consisting of aluminum, an aluminum alloy, and stainless steel.

The shape and thickness of the positive electrode current collector 12 are not particularly limited as long as it can collect current from the positive electrode layer 11, but examples of the shape of the positive electrode current collector 12 include a foil shape and a plate shape.

### <Negative Electrode>

The negative electrode 20 includes a negative electrode layer 21 and a negative electrode current collector 22. The negative electrode layer 21 is disposed on the solid electrolyte layer 30 side. The negative electrode current collector 22 constitutes a surface of the battery 1 on the negative electrode 20 side.

In the present invention, one feature is that the negative electrode layer 21 contains a silicon-based active material whose surface is at least partially coated with a coating layer, and a solid electrolyte.

According to the present invention, by using a coated active material coated with the coating layer as the negative electrode active material, the peeling between the active material and the solid electrolyte associated with expansion and contraction of the active material due to charge and discharge can be suppressed, and the reaction resistance during the cycle test can be reduced. The performance of the battery is greatly affected by the bonding state of the solid-solid interface of the active material, the conductive material, and the solid electrolyte. Meanwhile, the silicon-based active material is, for example, a next-generation material capable of rapid charging, but it is difficult to maintain a strong solid-solid interface because the volume change due to charge and discharge is large. On the other hand, in the present invention, at least a part of the surface of the active material is coated with a coating layer containing a specific metal element. Therefore, the peeling between the active material and the solid electrolyte associated with expansion and contraction of the active material can be suppressed, and the reaction resistance during the cycle test can be reduced. As a result, a strong solid-solid interface can be maintained, and battery characteristics such as cycle characteristics and capacity characteristics can be improved.

The negative electrode layer 21 contains a silicon-based active material as a negative electrode active material. The silicon-based active material is preferably an active material that can be alloyed with Li. Examples of the silicon-based active material include silicon alone, a silicon alloy, a silicon oxide, and a composite material containing silicon and a different element different from silicon. Examples of the silicon alloy include SiC, SiN, SiTi, SiAl, SiLi, and SiCu, and examples of the silicon oxide include SiO. Examples of the composite material containing silicon and a different element different from silicon include a composite material of silicon and lithium, a composite material of silicon and carbon, and a composite material of silicon and aluminum. The composite material containing silicon and a different element different from silicon may be a silicon alloy or may not be a silicon alloy.

The negative electrode active material is preferably a composite material containing silicon and a different element different from silicon. The composite material containing silicon and a different element different from silicon has a structure in which the different element alleviates the influence of expansion and contraction of silicon associated with charge and discharge. Therefore, the volume change due to expansion and contraction can be alleviated with respect to the silicon active material. With such a structure, the peeling between the active material and the solid electrolyte can be still further suppressed, and the reaction resistance during the cycle test can be still further reduced.

The negative electrode layer 21 may contain only a silicon-based active material as a negative electrode active material, or may contain another active material. In the latter case, the content of the silicon-based active material in all the negative electrode active materials may be 50% by mass or more, 70% by mass or more, or 90% by mass or more.

### <Coating Layer>

At least a part of the surface of the silicon-based active material is coated with a coating layer. That is, the negative electrode layer 21 may contain, as a negative electrode active material, a coated active material having a silicon-based active material and a coating layer coating the surface of the silicon-based active material and containing a specific metal element. The presence of the coating layer on the surface of the silicon-based active material makes it possible to suppress the peeling between the active material and the solid electrolyte associated with expansion and contraction of the active material and to reduce the reaction resistance during the cycle test.

The coating layer contains a metal element.

The metal element is a metal element capable of forming an alloy with lithium. In addition, as such a metal element, a practically available metal element is preferable, and examples thereof include Ni, In, Sb, Bi, Cu, Zn, Ga, Ge, As, Pd, Cu, Ag, Al, Cd, Sn, Pt, Au, Tl, Pb, P, and As.

The metal element contained in the coating layer is preferably Ni, In, Sb, or Bi. As a result, flexibility is provided to the coating layer, the coating layer easily follows a volume change of the active material, and easily contributes to enhancement of conduction paths of electrons and ions.

The metal element contained in the coating layer is more preferably Sb. Since Sb has high ion conductivity, it easily contributes to enhancement of conduction paths of electrons and ions as compared with a coating layer containing other metal elements.

Further, the coating layer may contain an alloy of a metal element and Li or an alloy of Sb and Li. The alloy of Sb and Li has a low expansion coefficient and flexibility as compared with other alloys, and easily follows the volume change of the active material. Therefore, it is considered that the peeling between the active material and the solid electrolyte is easily suppressed.

The thickness of the coating layer is preferably 10 nm or more and 100 nm or less, more preferably 15 nm or more and 80 nm or less, still more preferably 18 nm or more and 60 nm or less, and particularly preferably 20 nm or more and 40 nm or less. When the thickness of the coating layer is the above lower limit value or more, the strength of the coating layer can be increased, the conduction paths of electrons and ions can be maintained, and an increase in resistance can be suppressed. When the thickness of the coating layer is the above upper limit value or less, an increase in resistance due to the coating layer having an ionic conductivity lower than that of the solid electrolyte can be suppressed. On the other hand, when the thickness of the coating layer is less than the above lower limit value, the strength of the coating layer is insufficient, the conduction paths of electrons and ions cannot be maintained, and the increase in resistance cannot be suppressed. Also, when the thickness of the coating layer exceeds the above upper limit value, the coating layer itself becomes a resistance layer, and the resistance increases.

The thickness of the coating layer can be determined from a cross-sectional scanning electron microscope (SEM) image obtained by observing a cross section of the active material and the coating layer with SEM.

The mass ratio of the active material to the metal element is preferably 6:1 to 10:1, and more preferably 7:1 to 9:1. When the mass ratio of the active material to the metal element is within the above numerical range, the thickness of the coating layer can be controlled within the above preferable range, and the peeling between the active material and the solid electrolyte can be suppressed.

The volume ratio of the active material to the metal element is preferably 7:1 to 23:1, and more preferably 10:1 to 20:1. When the volume ratio of the active material to the metal element is within the above numerical range, the thickness of the coating layer can be controlled within the above preferable range, and the peeling between the active material and the solid electrolyte can be suppressed.

The content of the negative electrode active material in the negative electrode layer 21 is, for example, preferably 20% by mass or more, and may be 30% by mass or more, 40% by mass or more, or 50% by mass or more. On the other hand, the content of the negative electrode active material is, for example, preferably 99% by mass or less, and may be 90% by mass or less, 80% by mass or less, 70% by mass or less, or 60% by mass or less.

The negative electrode layer 21 contains a solid electrolyte. Here, the solid electrolyte contained in the negative electrode layer 21 is referred to as a first solid electrolyte with the intent to distinguish it from the solid electrolyte contained in the solid electrolyte layer 30 described later.

Examples of the first solid electrolyte include inorganic solid electrolytes such as a sulfide solid electrolyte, an oxide solid electrolyte, a nitride solid electrolyte, and a halide solid electrolyte.

The sulfide solid electrolyte usually contains a metal element (M) to be a conducting ion and sulfur(S). Examples of M include Li, Na, K, Mg, and Ca, and Li is used in the present embodiment in which Li ion conductivity is required.

In particular, the sulfide solid electrolyte of the present embodiment preferably contains Li, A (A is at least one selected from the group consisting of P, Si, Ge, Al, and B), and S. Further, A is preferably P (phosphorus). Furthermore, the sulfide solid electrolyte may contain a halogen such as Cl, Br, or I from the viewpoint of improving ion conductivity. In addition, the sulfide solid electrolyte may contain O (oxygen).

Since the sulfide solid electrolyte has high ion conductivity, even if some of a plurality of ion conduction paths are interrupted during the cycle test, ion conduction is maintained in the remaining paths, and as a result, the reaction resistance is suppressed.

In addition, the sulfide solid electrolyte has flexibility, and even when the volume of the coated active material changes, interfacial peeling and cracking are less likely to occur between the sulfide solid electrolyte and the coating layer, and the sulfide solid electrolyte can follow the volume change of the active material together with the coating layer, so that the interfacial peeling and cracking can be further suppressed.

As the sulfide solid electrolyte of the present embodiment having Li ion conductivity, for example, Li₂S—P₂S₅, Li₂S—P₂S₅—LiI, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—PS₅—ZₘSₙ (where m and n are positive numbers, and Z is any of Ge, Zn, and Ga), Li₂S—GeS₂, Li₂S—SiS₂—Li₃PO₄, Li₂S—SiS₂—LiₓMO_{y} (where x and y are positive numbers, and M is any of P, Si, Ge, B, Al, Ga, and In), LiᵥP_{w}SₓCl_{y}Br_{z} (v, w, x, y, z>0) or the like can be used. As the sulfide solid electrolyte, LiᵥP_{w}SₓCl_{y}Br_{z} (0<v<10, 0<w<5, 0<x<5, 0<y<5, 0<z<5) is preferably used from the viewpoint of maintaining the ion conductivity even during the cycle test and reducing the reaction resistance, and Li_{5.4}PS_{4.4}Cl_{0.8}Br_{0.8} or the like can be used.

Note that the above description of “Li₂S—P₂S₅” means a sulfide solid electrolyte obtained using a raw material composition containing Li₂S and P₂S₅, and the same applies to other descriptions.

In addition, the sulfide solid electrolyte may be sulfide glass or crystallized sulfide glass, or may be a crystalline material obtained by a solid phase method. Incidentally, the sulfide glass is obtained, for example, by performing a mechanical milling method (for example, a milling method using a ball mill) on the raw material composition. Also, the crystallized sulfide glass is obtained, for example, by heat-treating the sulfide glass at a temperature equal to or higher than the crystallization temperature.

The sulfide solid electrolyte is preferably an argyrodite-type sulfide solid electrolyte. The argyrodite-type sulfide solid electrolyte has flexibility, and even when the volume of the coated active material changes, interfacial peeling and cracking are less likely to occur between the sulfide solid electrolyte and the coating layer, and the sulfide solid electrolyte can follow the volume change of the active material together with the coating layer, so that the interfacial peeling and cracking can be further suppressed.

As the first solid electrolyte, in addition to the inorganic solid electrolyte described above, an oxide solid electrolyte or an organic solid electrolyte may be used. Examples of the oxide solid electrolyte include a solid electrolyte containing Li element, Y element (Y is at least one of Nb, B, Al, Si, P, Ti, Zr, Mo, W, and S), and O element. Examples of the organic solid electrolyte include polymer-based solid electrolytes such as polyethylene oxide-based polymer compounds, polymer compounds containing at least one of a polyorganosiloxane chain or a polyoxyalkylene chain, fluorine-based polymer compounds, and polyurethane-based polymer compounds.

Examples of the shape of the first solid electrolyte include a particulate shape. The average particle size of the first solid electrolyte is preferably 0.05 μm or more, more preferably 0.1 μm or more, and still more preferably 0.2 μm or more. On the other hand, the average particle size of the first solid electrolyte is preferably 20 μm or less, more preferably 10 μm, still more preferably 1 μm or less, and particularly preferably 0.7 μm or less. When the average particle size of the first solid electrolyte is less than 0.05 μm, the solid electrolytes are aggregated with each other at the time of forming a coating layer by the solid electrolyte on the surface of the active material, a uniform coating layer is not formed, and the peeling between the active material and the solid electrolyte associated with expansion and contraction of the active material cannot be suppressed. In addition, when the average particle size of the first solid electrolyte is more than 20 μm, the denseness of the coating layer is reduced, the interface formation between the active material and the coating layer becomes insufficient, and the peeling between the active material and the solid electrolyte associated with expansion and contraction of the active material cannot be suppressed.

The average particle size of the first solid electrolyte can be defined as D₅₀, and can be calculated, for example, by measurement with a laser diffraction particle size analyzer or a scanning electron microscope (SEM). In the case of measurement by SEM, the number of samples is preferably large, and may be, for example, 10 or more, 50 or more, or 100 or more. The upper limit of the number of samples is not particularly limited, but can be, for example, 100,000 or less.

The content of the first solid electrolyte in the negative electrode layer 21 is, for example, preferably 1% by mass or more, and may be 10% by mass or more or 20% by mass or more. On the other hand, the content of the first solid electrolyte in the negative electrode layer 21 is, for example, preferably 60% by mass or less, and may be 50% by mass or less or 40% by mass or less.

The negative electrode layer 21 preferably contains a conductive material in addition to the first solid electrolyte. This is because the electron conductivity in the negative electrode layer 21 is improved. Examples of the conductive material include a carbon material and a metal material. Examples of the carbon material include carbon black, acetylene black (AB), Ketjen black (KB), carbon nanotubes (CNT), metallic carbon nanotubes (MCNT), semiconductive carbon nanotubes (SCNT), and carbon nanofibers (CNF). Examples of the metal material include Ni, Cu, Fe, and SUS. Also, examples of the shape of the conductive material include a spherical shape and a fibrous shape.

The content of the conductive material in the negative electrode layer 21 is, for example, preferably 0.1% by mass or more, and may be 0.58 by mass or more. On the other hand, the content of the conductive material in the negative electrode layer 21 is, for example, preferably 5% by mass or less, and may be 3% by mass or less.

The negative electrode layer 21 may contain a binder as necessary. The binder is not particularly limited, and examples thereof include fluorine-based binders such as polyvinylidene fluoride (PVDF), polytetrafluoroethylene (PTFE), a polyvinylidene fluoride-polyhexafluoropropylene copolymer (PVDF-HFP), and fluororubber; and rubber-based binders such as butadiene rubber, hydrogenated butadiene rubber, styrene butadiene rubber (SBR), hydrogenated styrene butadiene rubber, nitrile butadiene rubber, hydrogenated nitrile butadiene rubber, and ethylene propylene rubber. In addition, an acrylic binder may be used.

The content of the binder in the negative electrode layer 21 is, for example, preferably 10% by mass or less, and may be 5% by mass or less or 3% by mass or less. On the other hand, the content of the binder in the negative electrode layer 21 is, for example, 0.1% by mass or more.

The thickness of the negative electrode layer 21 is, for example, preferably 0.1 μm or more and 1000 μm or less, more preferably 1 μm or more and 100 μm or less, and still more preferably 10 μm or more and 30 μm or less.

### <Solid Electrolyte Layer>

The solid electrolyte layer 30 is a layer formed between the positive electrode layer 11 and the negative electrode layer 21, contains at least a solid electrolyte, and may contain a binder as necessary. Since the contents of the solid electrolyte and the binder are the same as those described in <Negative Electrode> described above, the description thereof is omitted here. Also, the thickness of the solid electrolyte layer 30 may be, for example, in a range of 0.1 μm or more and 1000 μm or less.

The battery in the present invention may be an all-solid-state battery or a semi-solid-state battery. Examples of the all-solid-state battery include a battery having the above-described solid electrolyte layer 30.

Examples of the semi-solid-state battery include a battery in which the electrolyte layer contains a semi-solid electrolyte.

Examples of the semi-solid electrolyte include an electrolyte containing a polymer component and a standard electrolytic solution. Examples of the polymer component include polyvinylidene fluoride (PVDF)/polyethylene oxide (PEO), polyacrylonitrile (PAN)/PEO, polymethyl methacrylate (PMMA), PVDF/hexafluoropropylene (HFP), and other polymer components. Examples of the standard electrolytic solution include a 1 mol/L lithium hexafluorophosphate (LiPF₆) EC/DMC solution, a 1 mol/L LiPF₆ EC/ethyl methyl carbonate (EMC) solution, and a 1 mol/L LiPF₆ EC/DMC/EMC solution.

### [Manufacturing Method of Battery]

In the manufacturing method of a battery of the present invention, first, a coated active material in which at least a part of a surface of a silicon-based active material is coated with a coating layer is prepared (preparation step). Next, a negative electrode mixture containing a coated active material and a solid electrolyte is used to form a negative electrode layer (negative electrode layer forming step). In addition, a positive electrode layer and a solid electrolyte layer are formed based on known methods (positive electrode layer forming step, solid electrolyte layer forming step). A battery is obtained by laminating the positive electrode layer, the solid electrolyte layer, and the negative electrode layer in this order. The order of producing the layers and the order of laminating the layers are not particularly limited.

According to the present invention, by forming a negative electrode layer using a coated active material coated with a coating layer, a battery with reduced reaction resistance during the cycle test can be obtained.

### <Preparation Step>

The preparation step is a step of preparing a coated active material in which a surface of a silicon-based active material is coated with a coating layer. In the preparation step, a coating treatment for coating the surface of the silicon-based active material is performed.

The procedure of the coating treatment is as follows.
(i) A powder of a silicon-based active material is put into a polygonal barrel mounted in a cylindrical vacuum vessel.
(ii) The powder of the active material is stirred by rotating the polygonal barrel.
(iii) The inside of the vacuum vessel is brought into a vacuum state, and the inert gas is turned into plasma on a metal target.
(iv) By causing plasma to collide with the metal target, metal particles are emitted from the metal target.
(v) Metal particles adhere to and are coated on the surface of the powder of the active material being stirred.

In the coating treatment, unlike normal sputtering, sputtering is performed while rotating a cylindrical barrel (barrel sputtering). Specifically, the cylindrical barrel is rotated, and stirring is performed by a swing motion of the stirring arm. Therefore, the surface of the powder of the active material is uniformly coated with metal, and a coating layer having a uniform thickness is formed.

Detailed conditions in the coating treatment are as follows.

<<Detailed Conditions>>
Sputtering method: barrel sputtering
Input amount of active material: 35 g
Ultimate pressure: 9.9×10⁻⁴ Pa
Introduced gas: Ar
Operating pressure: 0.1 MPa
Baking conditions: 100° C., 15 minutes
Stirring: barrel swing
RF sputtering power supply output: 80 W
Film formation time: 12 hours

### <Negative Electrode Layer Forming Step>

The negative electrode layer forming step is a step of forming the negative electrode layer using a negative electrode mixture containing a silicon-based active material on which a coating layer is formed and a first solid electrolyte.

The negative electrode mixture contains at least a silicon-based active material on which a coating layer is formed and a first solid electrolyte, and may further contain at least one of a conductive material and a binder. That is, the negative electrode mixture contains the above-described coated active material.

In addition, the negative electrode mixture may or may not contain a dispersion medium.

As a method for forming the negative electrode layer, any known method can be adopted. Examples of the method for forming the negative electrode layer include a method in which a negative electrode slurry is applied and dried. The negative electrode slurry is obtained, for example, by kneading a negative electrode mixture (negative electrode mixture containing a dispersion medium).

Further, examples of the method include a method of forming a negative electrode layer by pressing a negative electrode mixture formed in a layer shape.

### <Other Steps>

The manufacturing method of a battery in the present embodiment usually includes a positive electrode layer forming step and a solid electrolyte layer forming step. As a method for forming the positive electrode layer and a method for forming the solid electrolyte layer, any known method can be adopted. Also, the battery obtained by these steps is the same as the contents described in the above [Lithium Ion Secondary Battery].

The present disclosure can also provide a method for producing a negative electrode active material for a solid battery including the preparation step described above. In this case, the negative electrode active material for a solid battery is preferably the above-described coated active material. Also, the present disclosure can also provide a method for producing a negative electrode layer for a solid battery including the preparation step and the negative electrode layer forming step described above.

According to the battery including the negative electrode including the coated active material and the solid electrolyte of the present embodiment as described above, the same effects as those of the negative electrode according to the present embodiment described above are exhibited.

The present invention is not limited to the above embodiments, and modifications and improvements within the scope of achieving the object of the present invention are included in the present invention.

### EXAMPLES

Next, examples of the present invention will be described, but the present invention is not limited to the examples below.

### Example 1

### [Preparation of Coated Active Material]

Sb (antimony) was used as a metal element used in the coating treatment in the preparation step. A composite material of silicon and carbon was used as a powder of a silicon-based active material, and a sputtering treatment was performed so that the mass ratio of the silicon-based active material and Sb was 6:1. 31.5 g of a coated active material was obtained by a barrel sputtering method under the following detailed conditions.

### <<Detailed Conditions>>

Input amount of active material: 35 g
Ultimate pressure: 9.9×10⁻⁴ Pa
Introduced gas: Ar
Operating pressure: 0.1 MPa
Baking conditions: 100° C., 15 minutes
Stirring: barrel swing
RF sputtering power supply output: 80 W
Film formation time: 12 hours

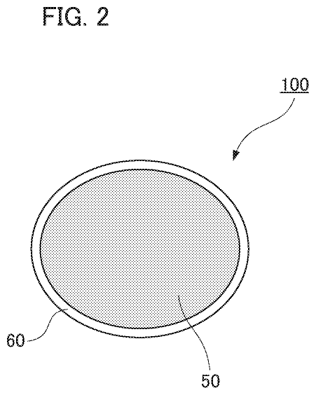

The obtained coated active material was resin-embedded in an epoxy resin, and treated with an argon ion beam under an inert atmosphere to prepare a cross-sectional sample. The cross-sectional sample was Pd coated on the surface to prevent charge-up. The prepared cross-sectional sample was analyzed by scanning electron microscope-energy dispersive X-ray spectroscopy (SEM-EDX). As the SEM, a scanning electron microscope (SEM) “SU8220” manufactured by Hitachi High-Tech Science Corporation was used to perform cross-sectional SEM observation at an accelerating voltage of 2.0 kV. FIG. 2 shows a schematic view showing an overall image of the coated active material obtained based on a cross-sectional SEM image.

As illustrated in FIG. 2, in a coated active material 100 of the present embodiment, it could be confirmed that a coating layer 60 was formed on the entire surface of a silicon-based active material 50. From the EDX analysis results, it could be confirmed that Sb was contained in the coating layer.

It could be also confirmed from the cross-sectional SEM image that the thickness of the coating layer 60 illustrated in FIG. 2 was about 20 nm.

### Examples 2 to 4, Comparative Example 1

A coated active material was obtained in the same manner as in Example 1 except that Ni (nickel) (Example 2), Bi (bismuth) (Example 3), and In (indium) (Example 4) were used as the metal element used in the coating treatment in the preparation step. For the obtained coated active material, a cross-sectional sample was prepared in the same manner as in Example 1, and SEM-EDX analysis was performed.

In addition, as a comparative example, a silicon-based active material on which no coating layer was formed was prepared (Comparative Example 1). The thickness of the coating layer of each example was determined from the cross-sectional SEM image, and the results are shown in Table 1. In Table 1, “-” means that no coating layer is formed.

### [Preparation of Negative Electrode Layer]

A negative electrode layer was prepared using the coated active material or the silicon-based active material obtained in each example. As the solid electrolyte, a sulfide solid electrolyte Li_{5.4}PS_{4.4}Cl_{0.8}Br_{0.8} was used. A fluorine-based binder was used as the binder, and carbon black was used as a conductive material. The mass ratio of the active material, the solid electrolyte, the binder, and the conductive material in the negative electrode layer was set to (active material/solid electrolyte/binder/conductive material)=(70/27/2/1).

### [Production of Half-Cell]

A sulfide solid electrolyte Li_{5.4}PS_{4.4}Cl_{0.8}Br_{0.8} was charged into a cylindrical ZrO₂ tube, and then pressed by being sandwiched between SUS jigs to obtain a solid electrolyte pellet. Next, the solid electrolyte pellet and the negative electrode layer obtained in each example were laminated, and then a molding pressure was applied to form a solid electrolyte layer. Next, a lithium foil was laminated on the solid electrolyte layer on the side opposite to the negative electrode layer, and then constrained at a constraining pressure of 3 MPa to obtain a half-cell.

### [Cycle Test]

Using the obtained half-cell of each example, a cycle test was performed under the following test conditions. The reaction resistance (during the 1-cycle test, during the 3-cycle test) and the ratio of the reaction resistance (reaction resistance during the 3-cycle test/reaction resistance during the 1-cycle test) in each example were determined, and the results are shown in Table 1.

### <<Test Conditions>>

$$1 Cycle = 0.1 C Charge and Discharge \times 3 Times \text{} + 0. 1 C Charge \times 1 Times \text{} + \text{} 1 / 3 C Discharge \times 1 Time$$

The reaction resistance between the active material and the solid electrolyte at 60% SOC (stage of charge) was measured.
Initial charge: 1400 mAh/g (corresponding to 60% SOC)
Constraint pressure: 3 MPa
Test temperature: 45° C.

TABLE 1

| | | | | | Comparative |
|---|---|---|---|---|---|
| | Example 1 | Example 2 | Example 3 | Example 4 | Example 1 |
| Type of metal element | Sb | Ni | Bi | In | — |
| Thickness of coating layer (nm) | 20 | 23 | 26 | 25 | — |
| Reaction resistance (Ω/cm²) | 0.9 | 1.3 | 1.2 | 1.3 | 1.4 |
| (during 1-cycle test) | | | | | |
| Reaction resistance (Ω/cm²) | 1.8 | 3.5 | 3.4 | 5.8 | 5.9 |
| (during 3-cycle test) | | | | | |
| Ratio of reaction resistance (%) | 194 | 265 | 287 | 456 | 430 |
| (3-cycle test/1-cycle test) | | | | | |

From Table 1, it was found that in Examples 1 to 4 having a coating layer, the reaction resistance was low during both the 1-cycle test and the 3-cycle test, and the electron conduction path and the ion conduction path between the active material and the solid electrolyte were enhanced, as compared with Comparative Example 1 having no coating layer. In addition, from the ratio of the reaction resistance during the 3-cycle test and the reaction resistance during the 1-cycle test, it was found that in Examples 1 to 3, the increase in the reaction resistance was suppressed as compared with Comparative Example 1, and the peeling of the solid electrolyte due to the volume change of the active material was suppressed by forming the coating layer.

What is claimed is:

1. A negative electrode comprising:
a silicon-based active material and a solid electrolyte, wherein
at least a part of a surface of the active material is coated with a coating layer, and
the coating layer contains a metal element capable of forming an alloy with lithium.

2. The negative electrode according to claim 1, wherein the metal element is at least one of Ni, In, Sb, and Bi.

3. The negative electrode according to claim 1, wherein the coating layer has a thickness of 10 nm or more and 100 nm or less.

4. The negative electrode according to claim 1, wherein the metal element is Sb.

5. The negative electrode according to claim 1, wherein the solid electrolyte is a sulfide solid electrolyte.

6. The negative electrode according to claim 1, wherein the active material is a composite material of silicon and a different element different from the silicon.

7. A lithium ion secondary battery comprising the negative electrode according to claim 1, a positive electrode, and a solid electrolyte layer.
